(19) United States
(12) Patent Application Publication
(10) Pub. No.: US 2024/0255064 A1
(43) Pub. Date: Aug. 1, 2024

(54) SAFETY VALVE AND DISCHARGE DIRECTION REGULATION MEMBER

(71) Applicants: FUJIKIN INCORPORATED, Osaka-shi (JP); JTEKT CORPORATION, Kariya-shi (JP)

(72) Inventors: Masashi Matsuoka, Osaka-shi (JP); Kunihiko Daido, Osaka-shi (JP); Tadayuki Yakushijin, Osaka-shi (JP); Koji Hiramatsu, Osaka-shi (JP); Yusei Horikawa, Osaka-shi (JP); Takao Kitanaka, Osaka-shi (JP); Kazushi Numazaki, Kariya-shi (JP); Natsuki Iwamoto, Kariya-shi (JP); Tetsuya Tokuno, Kariya-shi (JP)

(73) Assignees: FUJIKIN INCORPORATED, Osaka-shi (JP); JTEKT CORPORATION, Kariya-shi (JP)

(21) Appl. No.: 18/019,351

(22) PCT Filed: Jul. 29, 2021
(86) PCT No.: PCT/JP2021/028003

§ 371 Date: Feb. 2, 2023

(30) Foreign Application Priority Data
Aug. 3, 2020 (JP) 2020-131563

(51) Int. Cl. F16K 17/38

(52) U.S. Cl. CPC F16K 17/383

(57) ABSTRACT

To provide a safety valve capable of suppressing creep of a fusible alloy to the minimum even if a member that blocks a flow path directly presses the fusible alloy. A fusible alloy is disposed between a blocking member that blocks the flow of fluid flowing from a discharge path of a fluid apparatus and a pressing cap, a reservoir part 8 that reserves the fused fusible alloy is formed at least in one of the blocking member 3 and the pressing cap, and two porous plates punched positions of which do not overlap with each other are arranged between the reservoir part and the fusible alloy.

### TECHNICAL FIELD

The present invention relates to a safety valve for discharging fluid in a fluid apparatus safely to the outside and a discharge direction regulation member that regulates a direction of the fluid to be discharged to the outside for preventing a pressure inside the fluid apparatus from excessively increasing when the ambient temperature becomes high at the time of fire or the like.

### BACKGROUND ART

As such safety valve, there has been known a safety valve having a fusible element that fuses at the high temperature and discharging gas inside the fluid apparatus when a movable plug body moves along with the fusion of the fusible element (see Patent Literatures 1 to 2).

This kind of safety valves is particularly attached to an open end of a flow path for discharge branching from a flow path of the fluid apparatus where fluid flows thereinside to discharge the fluid such as gas in the fluid apparatus to the outside (atmosphere) when the ambient temperature increases at the occurrence of fire or other cases.

The safety valve according to Patent Literature 1 is attached to an opening at the open end onto the outside in the flow path branching from the fluid path of the fluid apparatus, which is configured to seal the opening so that fluid thereinside does not leak out to the outside in the normal state and to discharge gas in the fluid apparatus when the temperature increases to thereby prevent the inside the fluid apparatus from excessively pressure increasing.

The safely valve is provided with a cylindrical main body formed by a top wall and a peripheral wall, in which a lower end part of the peripheral wall is fixed to an opening edge part of the fluid apparatus, a flanged columnar moving member disposed inside the main body so as to move, a compression coil spring (elastic member) biasing the moving member to an upper direction, and a fusible element for the safety valve (fusible alloy) interposed between a lower surface of the top wall of the main body and an upper surface of the moving member. The inside of the main body communicates with the outside by a discharge path.

Then, communication between the lower end part of the peripheral wall and the inside of the fluid apparatus is blocked at a tip end of the moving member. When the fusible element fuses at the time of high temperature due to fire or the like, the moving member moves to the top wall side by a biasing force of the compression coil spring to thereby allow the inside of the main body of the safety valve to communicate with the inside of the fluid apparatus, as a result, fluid inside the fluid apparatus is released to the outside through the discharge path of the main body.

In the safety valve according to Patent Literature 1, the pressure inside a container is added to the fusible element (fusible alloy) through the moving member for inhibiting the flow of fluid inside the container to a discharge port in addition to a pressing force by the compression coil spring. Accordingly, a phenomenon that the fusible element is gradually deformed and flows toward a discharge port of the fusible element while keeping a solid state (creep phenomenon) may occur even in a prescribed temperature state. When this phenomenon excessively proceeds, there is a problem that the fluid in the container may be ejected to the outside even though fire or the like does not occur. “Creep” or the “creep phenomenon” in the description indicates a phenomenon that the fusible alloy having deformation (distortion) flows into a recessed part of a surface contacting the fusible alloy with lapse of time when a continuous pressing force is added to the fusible alloy.

In order to cope with the above problem, a member for preventing the flow of fluid inside the container to the discharge port (valve member) is provided as a separate body from the moving body that presses the fusible element, and moving directions of both members are directions orthogonal to each other in the safety valve according to Patent Literature 2. According to the structure described above, the valve member is locked by the moving member. When the fusing element fuses and the moving body is immersed along with temperature increase, the lock of the valve member with respect to the moving member is released and the fluid inside the container can be introduced to the discharge port.

### CITATION LIST

### Patent Literature

PTL 1: JP2012-132475A
PTL 2: JP2016-056822A

### SUMMARY OF INVENTION

### Technical Problem

However, there are problems, in the safety valve according to Patent Literature 2, that the entire size of the safety valve becomes large and the number of components is large, which leads to the increase in manufacturing costs. In addition to the above problems, in the case where the container to which the safety valve is attached is a fluid apparatus for a hydrogen vehicle (an apparatus for carrying hydrogen), it is necessary to regulate a discharge direction to a prescribed direction due to safety reasons when the safety valve is actuated to discharge fluid (hydrogen) in the apparatus to the outside.

The present invention has been made in view of the above problems, and an object thereof is to provide a safety valve capable of suppressing creep of the fusible alloy to the minimum even when a member for blocking the fluid path directly presses the fusible alloy. Another object of the invention is to provide a discharge direction regulation member capable of regulating the discharge direction of fluid ejected from the fluid apparatus to an appropriate direction when the safety valve is actuated.

### Solution to Problem

A safety valve according to the invention which has been made for solving the above first problem is installed in a fluid apparatus including a path for fluid thereinside and is provided with a path for discharge branching from the path for fluid, which includes a main body attached to an open end of the path for discharge of the fluid apparatus, in which an inflow path communicating with the path for discharge and a discharge path allowing the inflow path to communicate with the outside are formed and a blocking member that blocks the flow of fluid from the inflow path to an discharge path, in which the inflow path is connected to an abutting portion abutting on a sealing part formed at a tip end part of the blocking member to thereby block the flow of fluid and an open portion having a larger diameter than the abutting portion, the open portion communicates with the discharge path and forms an attachment portion for a pressing cap biasing the sealing part of the blocking member toward the abutting portion, a fusible alloy is disposed between the blocking member and the pressing cap, and a reservoir part that reserves the fused fusible alloy is formed at least in one of the blocking member and the pressing cap, and a plurality of porous plates punched positions of which do not overlap with each other are arranged between the reservoir part and the fusible alloy.

In the safety valve, the blocking member is pressed by a fluid pressure in the fluid apparatus, and the fusible alloy which is creeped though not being fused flows only into small holes on the first porous plate contacting the fusible alloy.

A discharge direction regulation member according to the invention which has been made for solving the above second problem regulates a discharge direction of fluid discharged from a safety valve having a cylindrical main body attached to a fluid apparatus including a path for fluid thereinside and is provided with a path for discharge branching from the path for fluid, which is formed of an annular body covering a discharge path of the main body of the safety valve provided with an inflow path communicating with the path for discharge and the discharge path allowing the inflow path to communicate with the outside, which includes a circumferential groove part on an inner circumferential surface corresponding to the discharge path, and a regulation discharge port which opens at a prescribed angle with respect to a central axis of the annular body communicating with the groove part and which communicates with the outside.

The discharge direction regulation member formed of the annular body turns with respect to the cylindrical main body and forms a regulation discharge port from an inner annular groove at a desired angle with respect to the central axis of the annular body; therefore, fluid to be discharged can be discharged in an arbitrary prescribed direction.

### Advantageous Effects of Invention

When applying the fusible-plug type safety valve according to the present invention, the creeped fusible alloy does not move forwarder than the small holes of the first porous plate abutting on the fusible alloy; therefore, the safety valve with no trouble that the safety valve malfunctions due to the creep by pressing caused by a fluid pressure in the fluid apparatus can be provided.

### BRIEF DESCRIPTION OF DRAWINGS

FIG. 1A and FIG. 1B show a safety valve according to an embodiment of the first invention, in which FIG. 1A is a front cross-sectional view showing a state within a prescribed temperature, and FIG. 1B is a front cross-sectional view showing a state exceeding a safety valve actuating temperature.

FIGS. 2A1, 2A2, 2B1 and 2B2 show porous plates used for the safety valve, in which FIG. 2A1 is a plan view of a porous plate of 1, FIG. 2A2 is a plan view of a porous plate in which positions of small holes do not correspond when overlaid on the porous plate of 1, FIG. 2B1 is a plan view showing a state where two porous plates are overlapped each other, and FIG. 2B2 is a cross-sectional view taken along A-A of FIG. 2B1.

FIG. 3A and FIG. 3B show porous plates used for the safety valve, in which FIG. 3A is a front view of part of a cutout just after installation, and FIG. 3B is a front view of part of the cutout in a state where a certain period passes at a prescribed temperature and creep occurs.

FIG. 4A and FIG. 4B show a safety valve according to another embodiment of the first invention, in which FIG. 4A is a front cross-sectional view showing a state within a prescribed temperature, and FIG. 4B is a front cross-sectional view showing a state exceeding a safety valve actuating temperature.

FIG. 5A and FIG. 5B show an example in which a reservoir part of the safety valve is formed on a pressing cap side, in which FIG. 5A is a front cross-sectional view showing a state within a prescribed temperature, and FIG. 5B is a bottom view thereof.

FIG. 6A, 6B, 6C, 6D show a discharge direction regulation member according to the second invention, in which FIG. 6A is a plan view, FIG. 6B is a side view, FIG. 6C is a cross-sectional view taken along B-B of FIG. 6A, and FIG. 6D is a perspective view of the B-B cross section.

### DESCRIPTION OF EMBODIMENTS

Hereinafter, embodiments of the present invention will be explained in detail with reference to the drawings. The following embodiments are substantially preferred examples and do not intend to limit the range of the present invention, applications or use thereof.

### Embodiment 1

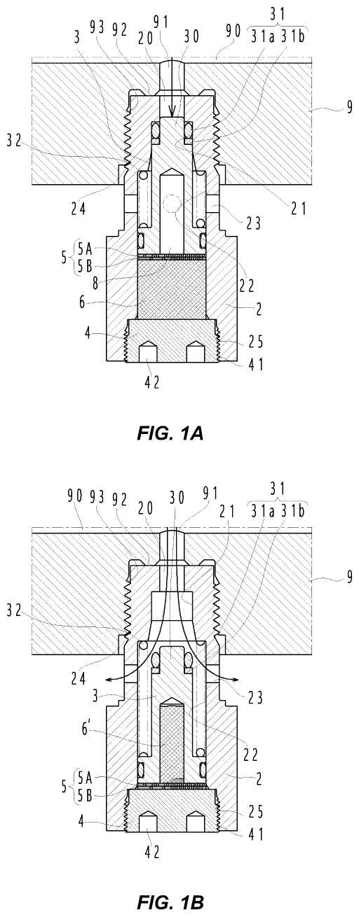

FIG. 1A to FIG. 3B show an embodiment of a safety valve as the first invention.

### [Safety Valve]

A safety valve 1 shown in FIG. 1A and FIG. 1B is installed in a fluid apparatus 9 having a path for fluid 90 thereinside and is provided with a path for discharge 91 branching from the path for fluid 90. For example, a tank storing fuel hydrogen for a fuel-cell car or the like can be cited as the fluid apparatus 9, though not particularly limited.

Then, the safety valve 1 is provided with a main body 2 attached to an open end of the path for discharge 91 of the fluid apparatus 9, which an inflow path 20 communicating with the path for discharge 91 and a discharge path 23 allowing the inflow path 20 to communicate with the outside are formed, and a blocking member 3 that blocks the flow of fluid from the inflow path 20 to an discharge path 23. The inflow path 20 is connected to an abutting portion 21 abutting on a sealing part 31 formed at a tip end part 30 of the blocking member 3 to thereby block the flow of fluid from the path for discharge 91 of the fluid apparatus 9 and an open portion 22 having a larger diameter than the abutting portion 21. The sealing part 31 formed at the tip end part 30 of the blocking member 3 is made up of an O-ring 31a and a back-up ring 31b in the embodiment; however, it is also preferable that the tip end part 30 is formed into a truncated cone shape and a step portion between the inflow path 20 and the abutting portion 21 is used as a valve seat to thereby perform sealing for the fluid. The blocking member 3 is biased in a direction in which the inflow path 20 communicates with the abutting portion 21 by an elastic member 32 such as a spring.

The open portion 22 connecting from the inflow path 20 communicates with the discharge path 23 and forms an attachment portion 25 for a pressing cap 4 for fixing the sealing part 31 of the blocking member 3 to the abutting portion 21. The inflow path 20, the abutting portion 21, and the open portion 22 are concentric with an axial center of the cylindrical main body 2, whereas the discharge path 23 opens in a direction approximately orthogonal to the axial center of the main body 2.

The pressing cap 4 has an external thread part 41 on a peripheral surface thereof and is provided with engaging portions 42 with which jigs and tools for turning the pressing cap 4 are engaged on a top surface thereof. In the attachment portion 25 of the main body 2, internal threads to which the external thread part 41 formed in the pressing cap 4 is screwed are grooved.

A fusible alloy 6 that fuses when reaching prescribed temperature is disposed between the blocking member 3 and the pressing cap 4. A reservoir part 8 that reserves the fused fusible alloy 6 is formed at least in one of the blocking member 3 and the pressing cap 4. The reservoir part 8 is formed on the blocking member 3 side in the embodiment. Then, two porous plates 5A, 5B punched positions of which do not overlap with each other are arranged between the reservoir part 8 and the fusible alloy 6.

### [Porous Plate]

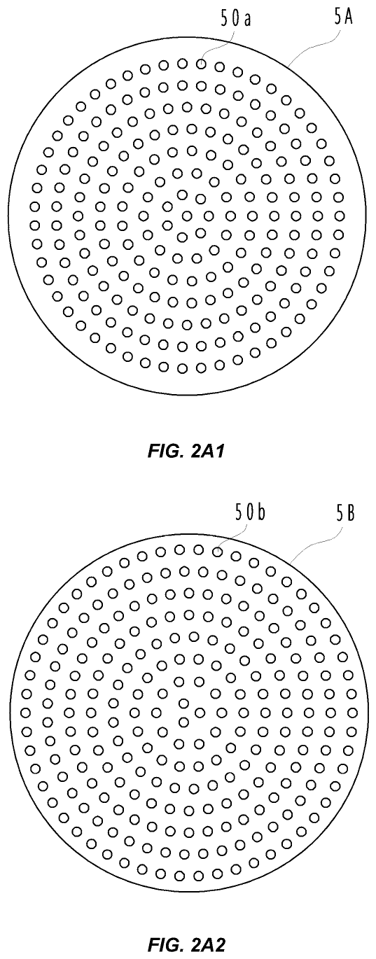

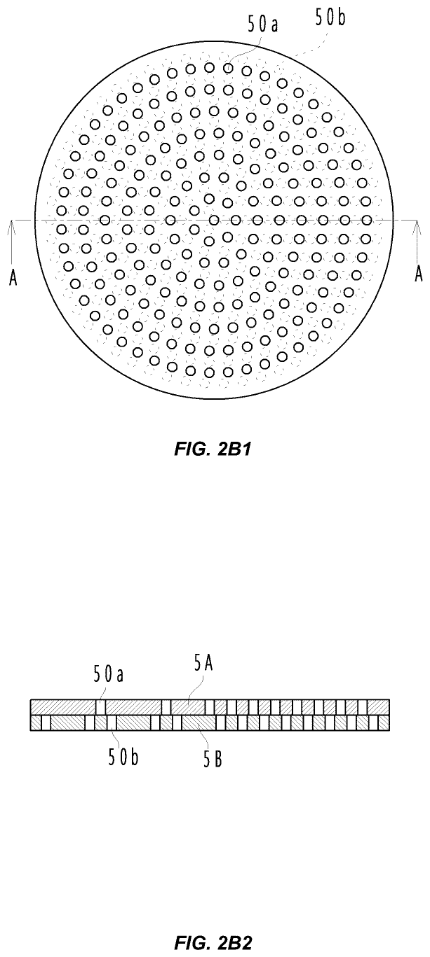

The porous plate 5 is formed by punching many small holes 50 in a thin plate (for example, a metal plate of 0.1 to 0.5 mm) as shown in FIG. 2A1 to FIG. 2B2. The two porous plates 5A, 5B have the same outer diameter and different punched positions of the small holes 50, which are formed so that small holes 50a on the porous plate 5A do not overlap with small holes 50b of the porous plate 5B when the porous plates 5A, 5B are overlapped each other and rotationally moved relatively.

Though an example in which the two porous plates 5A, 5B are used in the overlapping manner is shown in the embodiment, it is also preferable that three porous plates are used in the order of the porous plates 5A, 5B, and 5A.

In the above structure, the safety valve 1 is installed in the fluid apparatus 9 and the fluid apparatus 9 is actuated, a fluid pressure and a pressing force of the spring are applied to the blocking member 3, and a rear end side of the blocking member 3 presses the fusible alloy 6 through the porous plates 5A, 5B.

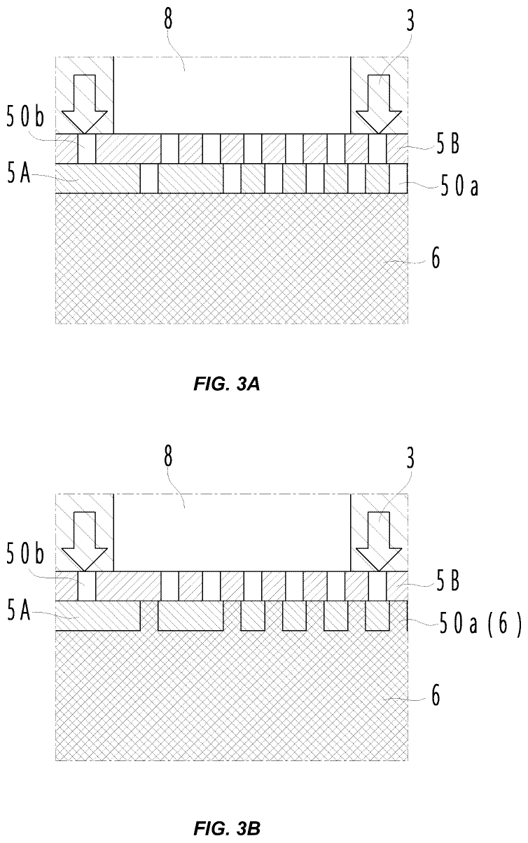

When the above state continues for a long time, the fusible alloy 6 does not fuse, but creep proceeds between the fusible alloy 6 and the porous plate 5A, and the fusible alloy 6 flows into the small holes 50a of the porous plate 5A from the state shown in FIG. 3A (see FIG. 3B).

However, the fusible alloy 6 flowing into the small holes 50a of the abutting porous plate 5A due to the creep phenomenon abuts on surfaces other than the small holes 50b of the second porous plate 5B, and the flowing due to the creep phenomenon remains inside the small holes 50a of the first porous plate 5A.

In the above structure, the inside of the path for fluid 90 of the fluid apparatus 9 and the inside of the path for discharge 91 branching from the path for fluid 90 are normally filled with fluid flowing in the fluid apparatus 9, and the pressure of the fluid is applied to the tip end part 30 of the blocking member 3 of the safety valve 1 installed in the fluid apparatus 9. Due to the pressure, the fusible alloy 6 flows into the small holes 50a of the porous plate 5A abutting on the fusible alloy 6 by the creep phenomenon; however, the fusible alloy 6 is blocked by surfaces other than the small holes 50b of the porous plate 5B. When fire occurs and the ambient temperature of the fluid apparatus 9 exceeds a prescribed temperature (a fusing temperature of the fusible alloy 6), the fusible alloy 6 begins to fuse.

The fusible alloy 6 beginning to fuse becomes liquid and flows into the reservoir part 8 through the small holes 50a of the porous plate 5A, gaps on an abutting surface between the porous plate 5A and the porous plate 5B, the small holes 50b of the porous plate 5B, and gaps on an abutting surface between the porous plate 5B and the blocking member 3 (flows directly into the reservoir part 8 in a central part).

When the fusible alloy 6 flows into the reservoir part 8 only by a given amount, the blocking member 3 biased to the fusible alloy 6 side by the elastic member 32 moves to the fusible alloy 6 side, and the sealing part 31 formed at the tip end part 30 is released from the abutting part 21 of the main body 2. Accordingly, the fluid in the fluid apparatus 9 is discharged from the inflow path 20 of the safety valve 1 toward the discharge path 23 (see FIG. 1B).

### Embodiment 2

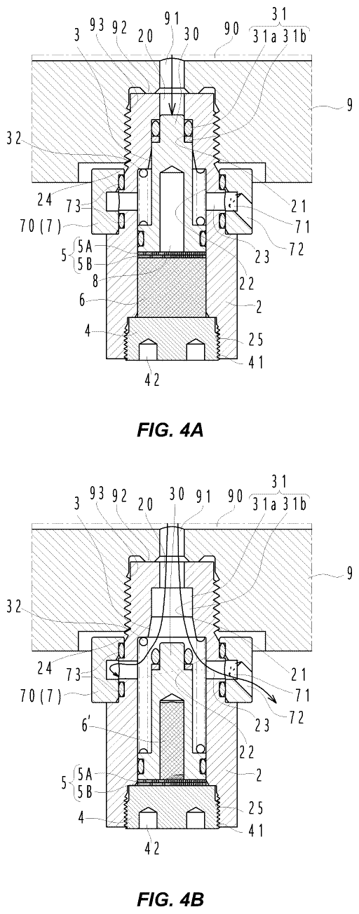

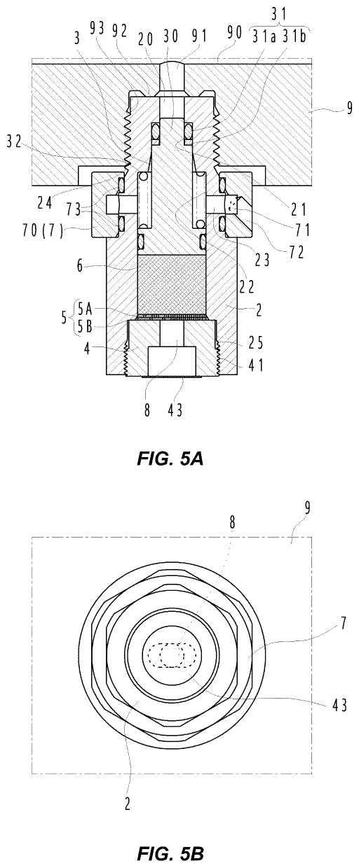

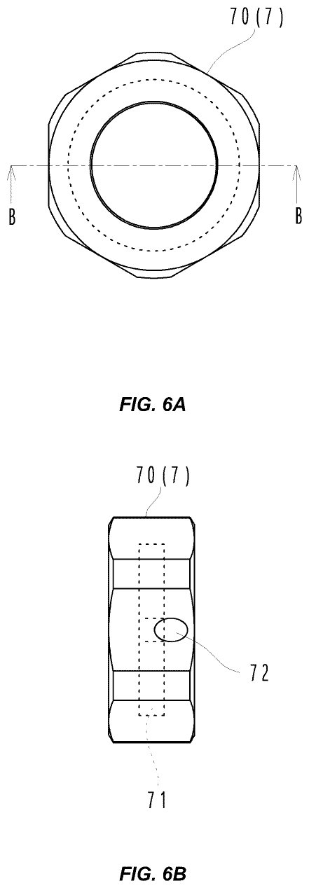

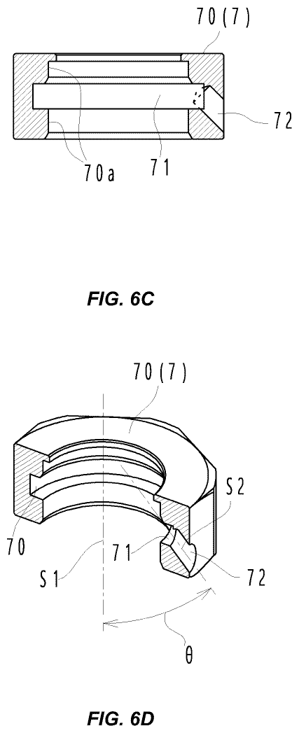

FIGS. 4A, 4B and FIGS. 5A and 5B show another embodiment of the safety valve in the first invention. This embodiment is configured by attaching a discharge direction regulation member as the second invention to the main body of the safety valve, which is shown in FIGS. 6A, 6B, 6C and 6D.

### [Safety Valve]

The safety valve 1 shown in FIG. 4A and FIG. 4B is installed in the fluid apparatus 9 having the path for fluid 90 thereinside and is provided with the path for discharge 91 branching from the path for fluid 90 in the same manner as Embodiment 1. The safety valve 1 is the same as Embodiment 1 in a point that the safety valve 1 is provided with the main body 2 attached to the open end of the path for discharge 91 of the fluid apparatus 9, in which the inflow path 20 and the discharge path 23 allowing the path for discharge 91 to communicate with the outside (atmosphere) are formed, and the blocking member 3 that blocks/connects between both flow paths, and explanation thereof is omitted.

The safety valve 1 according to the embodiment is configured by fitting a discharge direction regulation member 7 to the main body 2. The discharge direction regulation member 7 is formed of an annular body 70 covering the discharge path 23 of the cylindrical main body 2 of the safety valve 1, having a circumferential groove part 71 on an inner circumferential surface corresponding to the discharge path 23 and forming a regulation discharge port 72 which opens at a prescribed angle θ with respect to a central axis S1 of the annular body 70 communicating with the groove part 71 and which communicates with the outside. In this embodiment, the reservoir part 8 is formed on the blocking member 3 side in the same manner as Embodiment 1; however, it is also preferable that the reservoir part 8 is formed on the pressing cap 4 side as shown in FIG. 5A and FIG. 5B. In this case, the reservoir part 8 is formed into a shape with which jigs and tools for fastening the pressing cap 4 to the main body 2 can be engaged, which is, for example, a long hole (oval shape) or the like. Additionally, the reservoir part 8 is sealed with a sealing member such as a vent filter 43 after being fastened to the main body 2.

### [Discharge Direction Regulation Member]

The discharge direction regulation member 7 is shown in FIGS. 6A, 6B, 6C and 6D. The discharge direction regulation member 7 is the tubular annular body 70, which forms an inner diameter portion 70a slightly larger than an outer diameter of a portion where the discharge path 23 of the main body 2 opens and the groove part 71 having a larger diameter than the inner diameter portion 70a at a position corresponding to the discharge path 23 when attached to the main body 2.

An annular elastic member which is, for example, an O-ring is disposed between the inner diameter portion 70a and an outer circumferential surface of the main body 2 to thereby fix the attached discharge direction regulation member 7 so as not to come off easily. When the discharge direction regulation member 7 is installed in this manner, the discharge direction regulation member 7 can rotate freely with respect to the safety valve 1 and can determine a circumferential direction of the fluid discharged from the safety valve 1 freely.

The regulation discharge port 72 communicating with the groove part 71 forms the prescribed angle θ with respect to the central axis S1 of the annular body 70; therefore, the angle of the fluid discharged from the safety valve 1 in an axial direction can be determined freely.

In the above structure, for example, when an installation place of the safety valve 1 is the fluid apparatus 9 for the hydrogen vehicle (the apparatus for carrying hydrogen), the safety valve 1 is disposed on a bottom surface of the fluid apparatus 9. In the case of the hydrogen vehicle, it is requested that the fluid (hydrogen) thereinside is discharged toward a lower side in the rear direction when an accident such as fire occurs. In order to cope with the request, the regulation discharge port 72 of the discharge direction regulation member 7 opens to the lower side so that 0 is approximately 30 to 50 degrees with respect to the central axis S1 of the annular body 70 in the safety valve 1 according to the invention. Then, after the safety valve 1 is installed in the fluid apparatus 9, the discharge direction regulation member 7 is set so that the regulation discharge port 72 faces the rear direction by rotating the discharge direction regulation member 7 with respect to the main body 2. According to the above, when an accident such as fire in which the ambient temperature becomes high occurs and the safety valve 1 is actuated, the fluid (hydrogen) inside the fluid apparatus 9 is ejected toward the rear lower side.

The present invention has been explained on the basis of preferred embodiments thereof, and the present invention is not limited to these specific embodiments but various examples are also included in the present invention in a scope not departing from the gist of the invention. The respective embodiments and modification examples described above indicate one aspect of the present invention, and respective embodiments can be combined appropriately.

This application claims the priority to Japanese Patent Application 2020-131563 filed on Aug. 3, 2020, and the content thereof is incorporated herein by reference in its entirety.

### INDUSTRIAL APPLICABILITY

The safety valve according to the present invention can be suitably used for a system in which the fluid inside the fluid apparatus needs to be released to the outside when the ambient temperature is rapidly increased due to occurrence of fire or the like, and can be also suitably used for environmental equipment in which occurrence of secondary disaster have to be prevented by regulating the discharge direction of the fluid to be ejected at the occurrence of fire or the like by using the discharge direction regulation member.

### REFERENCE SIGNS LIST

1: safety valve
2: main body
20: inflow path
21: abutting portion
22: open portion
23: discharge path
25: attachment portion
3: blocking member
30: tip end part
31: sealing part
4: pressing cap
5: porous plate
50: small hole
6: fusible alloy
7: discharge direction regulation member
70: annular body
71: groove part
72: regulation discharge port
8: reservoir part
9: fluid apparatus
90: path for fluid
91: path for discharge

1. A safety valve installed in a fluid apparatus including a path for fluid thereinside and is provided with a path for discharge branching from the path for fluid, comprising:
a main body attached to an open end of the path for discharge of the fluid apparatus, in which an inflow path communicating with the path for discharge and a discharge path allowing the inflow path to communicate with the outside are formed; and
a blocking member that blocks the flow of fluid from the inflow path to a discharge path,
wherein the inflow path is connected to an abutting portion abutting on a sealing part formed at a tip end part of the blocking member to thereby block the flow of fluid and an open portion having a larger diameter than the abutting portion,
the open portion communicates with the discharge path and forms an attachment portion for a pressing cap biasing the sealing part of the blocking member toward the abutting portion,
a fusible alloy is disposed between the blocking member and the pressing cap, and a reservoir part that reserves the fused fusible alloy is formed at least in one of the blocking member and the pressing cap, and
a plurality of porous plates punched positions of which do not overlap with each other are arranged between the reservoir part and the fusible alloy.

2. A discharge direction regulation member that regulates a discharge direction of fluid discharged from a safety valve having a cylindrical main body attached to a fluid apparatus including a path for fluid thereinside and is provided with a path for discharge branching from the path for fluid, which is formed of an annular body covering a discharge path of the main body of the safety valve provided with an inflow path communicating with the path for discharge and the discharge path allowing the inflow path to communicate with the outside, comprising:
a circumferential groove part on an inner circumferential surface corresponding to the discharge path; and
a regulation discharge port which opens at a prescribed angle with respect to a central axis of the annular body communicating with the groove part and which communicates with the outside.

3. The safety valve according to claim 1, further comprising:
a discharge direction regulation member that regulates a discharge direction of fluid discharged from a safety valve having a cylindrical main body attached to a fluid apparatus including a path for fluid thereinside and is provided with a path for discharge branching from the path for fluid, which is formed of an annular body covering a discharge path of the main body of the safety valve provided with an inflow path communicating with the path for discharge and the discharge path allowing the inflow path to communicate with the outside, comprising:
a circumferential groove part on an inner circumferential surface corresponding to the discharge path; and
a regulation discharge port which opens at a prescribed angle with respect to a central axis of the annular body communicating with the groove part and which communicates with the outside.
